(19) United States
(12) Patent Application Publication
(10) Pub. No.: US 2018/0338345 A1
(43) Pub. Date: Nov. 22, 2018

(54) METHOD AND APPARATUS FOR RELAY DUPLEXING IN WIRELESS LAN

(71) Applicant: NEWRATEK, Inc., Daejeon (KR)

(72) Inventor: Je Hun LEE, Seoul (KR)

(21) Appl. No.: 15/675,369

(22) Filed: Aug. 11, 2017

(30) Foreign Application Priority Data
May 18, 2017 (KR) 10-2017-0061819

(51) Int. Cl. H04W 84/12; H04L 5/14

(52) U.S. Cl. CPC H04W 84/12; H04B 7/026; H04L 5/14

(57) ABSTRACT

The present disclosure relates to a method and apparatus for relay duplexing in a wireless local area network. In an aspect of the present disclosure, a method for relay duplexing in a wireless local area network may be provided. The method may include monitoring, by a backup station (STA), a status of a relay; when determining that a failure occurred at the relay, activating the backup STA as a relay; and establishing, by the backup STA, an association with a STA that has been associated with the relay.

### CROSS-REFERENCE TO RELATED APPLICATIONS

This application claims the benefits of Korean Patent Application No. 10-2017-0061819, filed on May 18, 2017, which is hereby incorporated by reference as if fully set forth herein.

### BACKGROUND

### Technical Field

The present disclosure relates to Wireless Local Area Networks (WLANs), and more particularly, to a method and apparatus for a relay duplexing in a WLAN.

### Related Art

Along with the recent development of information and telecommunication technology, various wireless communication techniques have been developed. Among them, the WLAN enables a user to wirelessly access the Internet based on radio frequency technology in a home, an office, or a specific service area using a portable terminal such as a Personal Digital Assistant (PDA), a laptop computer, a Portable Multimedia Player (PMP), a smartphone, etc.

To overcome limitations in communication speed that the WLAN faces, the recent technical standards have introduced a system that increases the speed, reliability, and coverage of a wireless network. For example, the Institute of Electrical and Electronics Engineers (IEEE) 802.11ac standard has introduced Multiple Input Multiple Output (MIMO) that is implemented using multiple antennas at both a transmitter and a receiver in order to support Very High Throughput (VHT) at a data processing rate of up to 6.77 Gbps, minimize transmission errors, and optimize data rates.

As a next generation communication technology, Internet of Things (IoT) communication technology is being developed. For IEEE 802.11 WLAN system, a technology standard to support IoT communication is defined by a task group named IEEE 802.11ah. For IoT communication, it may be considered that a circumstance of a massive number of devices (or nodes) complicatedly connected and a scenario of each device performing communications at times, which are supported by various technologies defined by IEEE 802.11ah task group.

In addition, IEEE 802.11ah task group supports operations in Sub-1 GHz (S1G) unlicensed band and defines operations of MAC (Medium Access Control) layer and PHY (Physical) layer for supporting extending transmission range up to lkm and minimum data rate of 100 Kb/s. One of technologies to support the aforementioned operations, it is defined to introduce relay.

However, there is no specific solution to solve problems due to relay failure.

### SUMMARY

The present disclosure describes embodiments of a method and apparatus for preventing network failure situation due to relay functional failure.

The present disclosure describes embodiments of a method and apparatus for relay duplexing for prompt action to deal with relay failure situation.

The embodiments contemplated by the present disclosure are not limited to the foregoing descriptions, and additional embodiments will become apparent to those having ordinary skill in the pertinent art to the present disclosure based upon the following descriptions.

In an aspect of the present disclosure, a method for relay duplexing in a wireless local area network may be provided. The method may include monitoring, by a backup station (STA), a status of a relay; when determining that a failure occurred at the relay, activating the backup STA as a relay; and establishing, by the backup STA, an association with a STA that has been associated with the relay.

It is to be understood that the foregoing summarized features are exemplary aspects of the following detailed description of the present disclosure and are not intended to limit the scope of the present disclosure.

According to the present disclosure, a method and apparatus for preventing network failure situation due to relay functional failure can be provided.

According to the present disclosure, a method and apparatus for relay duplexing for prompt action to deal with relay failure situation can be provided.

The advantages of the present disclosure are not limited to the foregoing descriptions, and additional advantages will become apparent to those having ordinary skill in the pertinent art to the present disclosure based upon the following descriptions.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a block diagram of a Wireless Local Area Network (WLAN) device;

FIG. 2 is a schematic block diagram of an exemplary transmitting signal processing unit in a WLAN;

FIG. 3 is a schematic block diagram of an exemplary receiving signal processing unit in a WLAN;

FIG. 4 depicts an exemplary frame structure in a WLAN system;

FIG. 5 depicts a relay architecture in a WLAN system.

FIG. 6 depicts a network architecture according to the present disclosure.

FIG. 7 depicts a relay duplexing operation according to the present disclosure.

FIGS. 8A to 8E depict frame formats defined for supporting relay duplexing operation according to the present disclosure.

FIG. 9 depicts specified operations of an initializing step according to the present disclosure.

FIG. 10 depicts specified operations of a synchronization performing step according to the present disclosure.

FIG. 11 depicts specified operations of a recovering step according to the present disclosure.

### DETAILED DESCRIPTION

In the following detailed description, certain embodiments of the present disclosure have been shown and described, by way of illustration. As those skilled in the art would realize, the described embodiments may be modified in various different ways, without departing from the spirit or scope of the present disclosure. Accordingly, the drawings and description are to be regarded as illustrative in nature and not restrictive. Like reference numerals designate like elements throughout the present disclosure.

In a Wireless Local Area network (WLAN), a Basic Service Set (BSS) includes a plurality of WLAN devices. A WLAN device may include a Medium Access Control (MAC) layer and a PHYsical (PHY) layer according to Institute of Electrical and Electronics Engineers (IEEE) 802.11 series standards. In the plurality of WLAN devices, at least one the WLAN device may be an Access Point (AP) and the other WLAN devices may be non-AP Stations (non-AP STAs). Alternatively, all of the plurality of WLAN devices may be non-AP STAs in an ad-hoc networking environment. In general, AP STA and non-AP STA may be each referred to as an STA or may be collectively referred to as STAs. However, for ease of description herein, only the non-AP STAs may be referred to herein as STAs.

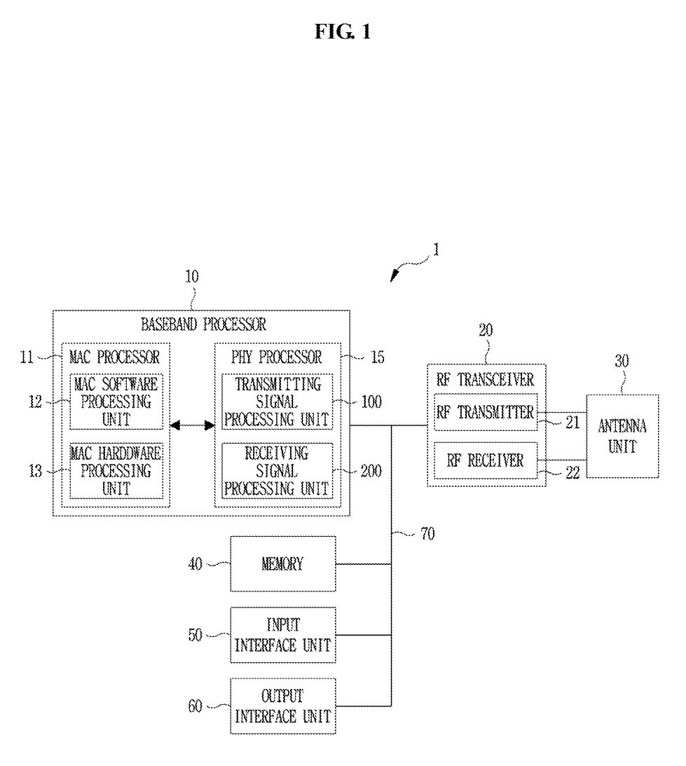

FIG. 1 is a block diagram of a WLAN device.

Referring to FIG. 1, a WLAN device 1 includes a baseband processor 10, a Radio Frequency (RF) transceiver 20, an antenna unit 30, a memory 40, which may be or may include a non-transitory computer-readable medium, an input interface unit 50, an output interface unit 60, and a bus 70.

The baseband processor 10 may be simply referred to as a processor, and may perform baseband signal processing described in the present disclosure, and includes a MAC processor (or MAC entity) 11 and a PHY processor (or PHY entity) 15.

In an embodiment of the present disclosure, the MAC processor 11 may include a MAC software processing unit 12 and a MAC hardware processing unit 13. The memory 40 may store software or machine-executable instructions (hereinafter referred to as ‘MAC software’) including at least some functions of the MAC layer. The MAC software processing unit 12 may execute the MAC software to implement some functions of the MAC layer, and the MAC hardware processing unit 13 may implement the remaining functions of the MAC layer as hardware (hereinafter referred to as ‘MAC hardware’). However, embodiments of the MAC processor 11 are not limited to this distribution of functionality.

The PHY processor 15 includes a transmitting (TX) signal processing unit 100 and a receiving (RX) signal processing unit 200.

The baseband processor 10, the RF transceiver 20, the memory 40, the input interface unit 50, and the output interface unit 60 may communicate with one another via the bus 70.

The RF transceiver 20 includes an RF transmitter 21 and an RF receiver 22.

The memory 40 may further store an Operating System (OS) and applications. The input interface unit 50 receives information from a user, and the output interface unit 60 outputs information to the user.

The antenna unit 30 includes one or more antennas. When Multiple Input Multiple Output (MIMO) or Multi-User MIMO (MU-MIMO) is used, the antenna unit 30 may include a plurality of antennas.

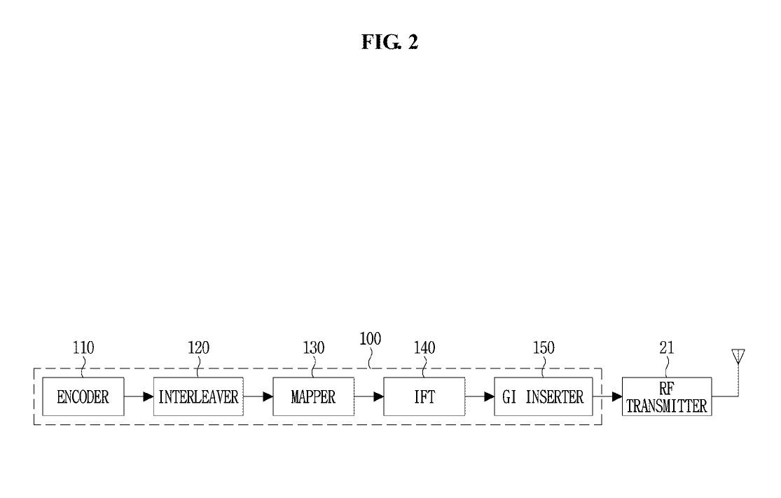

FIG. 2 is a schematic block diagram of an exemplary transmitting signal processor in a WLAN.

Referring to FIG. 2, the transmitting signal processing unit 100 may include an encoder 110, an interleaver 120, a mapper 130, an Inverse Fourier Transformer (IFT) 140, and a Guard Interval (GI) inserter 150.

The encoder 110 encodes input data. For example, the encoder 100 may be a Forward Error Correction (FEC) encoder. The FEC encoder may include a Binary Convolutional Code (BCC) encoder followed by a puncturing device, or the FEC encoder may include a Low-Density Parity-Check (LDPC) encoder.

The transmitting signal processing unit 100 may further include a scrambler for scrambling the input data before encoding to reduce the probability of long sequences of 0s or 1s. If BCC encoding is used in the encoder 110, the transmitting signal processing unit 100 may further include an encoder parser for demultiplexing the scrambled bits among a plurality of BCC encoders. If LDPC encoding is used in the encoder 110, the transmitting signal processing unit 100 may not use the encoder parser.

The interleaver 120 interleaves the bits of each stream output from the encoder 110 to change the order of bits. Interleaving may be applied when BCC encoding is used in the encoder 110. The mapper 130 maps the sequence of bits output from the interleaver 120 to constellation points. If LDPC encoding is used in the encoder 110, the mapper 130 may further perform LDPC tone mapping in addition to constellation mapping.

When MIMO or MU-MIMO is used, the transmitting signal processing unit 100 may use a plurality of interleavers 120 and a plurality of mappers 130 corresponding to the number of spatial streams, N_{SS}. In this case, the transmitting signal processing unit 100 may further include a stream parser for dividing outputs of the BCC encoders or output of the LDPC encoder into blocks that are sent to different interleavers 120 or mappers 130. The transmitting signal processing unit 100 may further include a Space-Time Block Code (STBC) encoder for spreading the constellation points from the N_{SS} spatial streams into N_{STS} space-time streams and a spatial mapper for mapping the space-time streams to transmit chains. The spatial mapper may use direct mapping, spatial expansion, or beamforming.

The IFT 140 converts a block of constellation points output from the mapper 130 or the spatial mapper to a time-domain block (i.e., a symbol) by using Inverse Discrete Fourier Transform (IDFT) or Inverse Fast Fourier Transform (IFFT). If the STBC encoder and the spatial mapper are used, the IFT 140 may be provided for each transmit chain.

When MIMO or MU-MIMO is used, the transmitting signal processing unit 100 may insert Cyclic Shift Diversities (CSDs) to prevent unintentional beamforming. The CSD insertion may occur before or after IFT. The CSD may be specified per transmit chain or may be specified per space-time stream. Alternatively, the CSD may be applied as a part of the spatial mapper.

When MU-MIMO is used, some blocks before the spatial mapper may be provided for each user.

The GI inserter 150 prepends a GI to the symbol. The transmitting signal processing unit 100 may optionally perform windowing to smooth edges of each symbol after inserting the GI. The RF transmitter 21 converts the symbols into an RF signal and transmits the RF signal via the antenna unit 30. When MIMO or MU-MIMO is used, the GI inserter 150 and the RF transmitter 21 may be provided for each transmit chain.

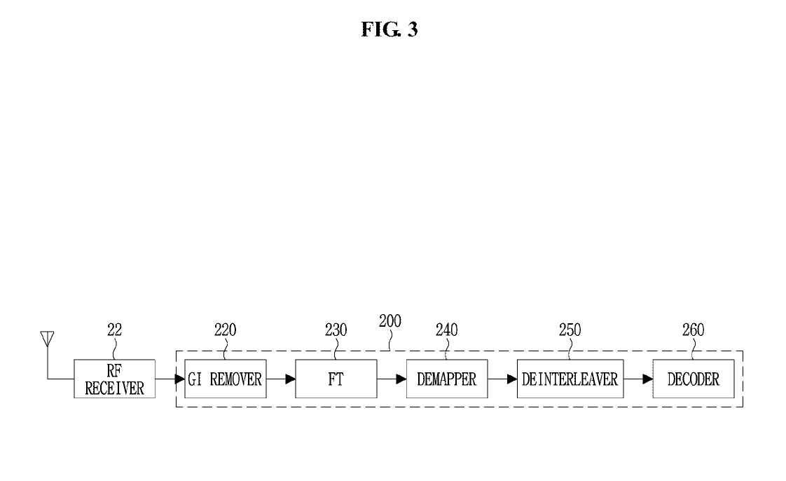

FIG. 3 is a schematic block diagram of an exemplary receiving signal processor in a WLAN.

Referring to FIG. 3, the receiving signal processing unit 200 includes a GI remover 220, a Fourier Transformer (FT) 230, a demapper 240, a deinterleaver 250, and a decoder 260.

An RF receiver 22 receives an RF signal via the antenna unit 30 and converts the RF signal into one or more symbols. The GI remover 220 removes the GI from the symbol. When MIMO or MU-MIMO is used, the RF receiver 22 and the GI remover 220 may be provided for each receive chain.

The FT 230 converts the symbol (i.e., the time-domain block) into a block of constellation points by using a Discrete Fourier Transform (DFT) or a Fast Fourier Transform (FFT). The FT 230 may be provided for each receive chain.

When MIMO or MU-MIMO is used, the receiving signal processing unit 200 may use/include a spatial demapper for converting Fourier Transformed receiver chains to constellation points of the space-time streams, and an STBC decoder for despreading the constellation points from the space-time streams into the spatial streams.

The demapper 240 demaps the constellation points output from the FT 230 or the STBC decoder to bit streams. If LDPC encoding is applied to the received signal, the demapper 240 may further perform LDPC tone demapping before constellation demapping. The deinterleaver 250 deinterleaves the bits of each stream output from the demapper 240. Deinterleaving may be applied when a BCC encoding scheme is applied to the received signal.

When MIMO or MU-MIMO is used, the receiving signal processing unit 200 may use a plurality of demappers 240 and a plurality of deinterleavers 250 corresponding to the number of spatial streams. In this case, the receiving signal processing unit 200 may further include a stream deparser for combining streams output from the deinterleavers 250.

The decoder 260 decodes the streams output from the deinterleaver 250 or the stream deparser. For example, the decoder 100 may be an FEC decoder. The FEC decoder may include a BCC decoder or an LDPC decoder. The receiving signal processing unit 200 may further include a descrambler for descrambling the decoded data. If BCC decoding is used in the decoder 260, the receiving signal processing unit 200 may further include an encoder deparser for multiplexing the data decoded by a plurality of BCC decoders. If LDPC decoding is used in the decoder 260, the receiving signal processing unit 200 may not use the encoder deparser.

In a WLAN system, Carrier Sense Multiple Access with Collision Avoidance (CSMA/CA) is a basic MAC access mechanism. The CSMA/CA mechanism is referred to as Distributed Coordination Function (DCF) of IEEE 802.11 MAC, or colloquially as a ‘listen before talk’ access mechanism. According to the CSMA/CA mechanism, an AP and/or an STA may sense a medium or a channel for a predetermined time before starting transmission, that is, the AP and/or the STA may perform Clear Channel Assessment (CCA). If the AP or the STA determines that the medium or channel is idle, it may start to transmit a frame on the medium or channel. On the other hand, if the AP and/or the STA determines that the medium or channel is occupied or busy, it may set a delay period (e.g., a random backoff period), wait for the delay period without starting transmission, and then attempt to transmit a frame. By applying a random backoff period, a plurality of STAs are expected to attempt frame transmission after waiting for different time periods, resulting in less collisions.

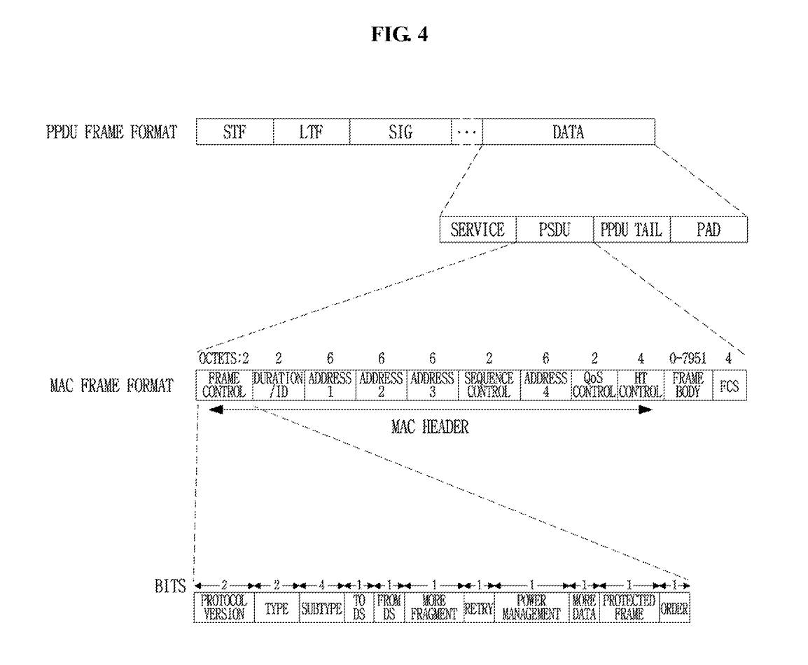

FIG. 4 depicts an exemplary frame structure in a WLAN system.

PHY layer may prepare for transmission of a MAC PDU (MPDU) in response to an instruction (or a primitive, which is a set of instructions or a set of parameters) by the MAC layer. For example, upon receipt of an instruction requesting transmission start from the MAC layer, the PHY layer may switch to a transmission mode, construct a frame with information (e.g., data) received from the MAC layer, and transmit the frame.

Upon detection of a valid preamble in a received frame, the PHY layer monitors a header of the preamble and transmits an instruction indicating reception start of the PHY layer to the MAC layer.

Information is transmitted and received in frames in the WLAN system. For this purpose, a Physical layer Protocol Data Unit (PPDU) frame format is defined.

A PPDU frame may include a Short Training Field (STF) field, a Long Training Field (LTF) field, a SIGNAL (SIG) field, and a Data field. The most basic (e.g., a non-High Throughput (non-HT)) PPDU frame may include only a Legacy-STF (L-STF) field, a Legacy-LTF (L-LTF) field, a SIG field, and a Data field. Additional (or other types of) STF, LTF, and SIG fields may be included between the SIG field and the Data field according to the type of PPDU frame format (e.g., an HT-mixed format PPDU, an HT-greenfield format PPDU, a Very High Throughput (VHT) PPDU, etc.).

The STF is used for signal detection, Automatic Gain Control (AGC), diversity selection, fine time synchronization, etc. The LTF field is used for channel estimation, frequency error estimation, etc. The STF and the LTF fields may be referred to as signals for OFDM PHY layer synchronization and channel estimation.

The SIG field may include a RATE field and a LENGTH field. The RATE field may include information about a modulation scheme and coding rate of data. The LENGTH field may include information about the length of the data. The SIG field may further include parity bits, SIG TAIL bits, etc.

The Data field may include a SERVICE field, a Physical layer Service Data Unit (PSDU), and PPDU TAIL bits. When needed, the Data field may further include padding bits. Some of the bits of the SERVICE field may be used for synchronization at a descrambler of a receiver. The PSDU corresponds to a MAC PDU defined at the MAC layer and may include data generated/used in a higher layer. The PPDU TAIL bits may be used to return an encoder to a zero state. The padding bits may be used to match the length of the Data filed in predetermined units.

A MAC PDU is defined according to various MAC frame formats. A basic MAC frame includes a MAC header, a frame body, and a Frame Check Sequence (FCS). The MAC frame includes a MAC PDU and may be transmitted and received in the PSDU of the data part in the PPDU frame format.

The MAC header includes a Frame Control field, a Duration/Identifier (ID) field, an Address field, etc. The Frame Control field may include control information required for frame transmission/reception. The Duration/ID field may be set to a time for transmitting the frame. For details of Sequence Control, QoS Control, and HT Control subfields of the MAC header, refer to the IEEE 802.11-2012 technical specification, which is hereby incorporated by reference.

The Frame Control field of the MAC header may include Protocol Version, Type, Subtype, To Distribution System (DS), From DS, More Fragment, Retry, Power Management, More Data, Protected Frame, and Order subfields. For the contents of each subfield in the Frame Control field, refer to the IEEE 802.11-2012 technical specification.

A Null-Data Packet (NDP) frame format is a frame format that does not include a data packet. In other words, the NDP frame format includes a Physical Layer Convergence Protocol (PLCP) header part (i.e., the STF, LTF, and SIG fields) of the general PPDU frame format, without the remaining part (i.e., the Data field) of the general PPDU frame format. The NDP frame format may be referred to as a short frame format.

Relay duplexing schemes in a WLAN according to the present disclosure will be described. Specifically, relay duplexing schemes in an IoT network (e.g., S1G network according to IEEE 802.11ah standard).

FIG. 5 depicts a relay architecture in a WLAN system.

A relay function may be added to support complicated connections of a massive number of nodes in an IoT network. A relay in a WLAN corresponds to mechanism for extending coverage area of an AP (i.e., a root AP).

A relay may include “a relay AP” and “a relay STA.” That is, to upper side, a relay may function as a relay STA associated with an AP (i.e., a root AP, or a relay AP of another relay), to lower side, a relay may function as a relay AP associated with another STA (i.e., non-AP STA, or a relay STA of another relay). A relay may forward a frame from a STA associated with a relay AP toward a root AP, or forward a frame from a root AP toward a STA associated with a relay AP.

That is, Relay2 may specifically include a relay STA belonging to an upper BSS, a relay AP providing a lower BSS, and a relay function performing functions for a local logical link control (LLC). Such relay architecture may be implemented by MAC layer. For example, a relay configuration may be implemented by a hardware, a software, a firmware, or a combination thereof.

In an example of FIG. 5, a relay STA of Relay2 may be associated with Root AP, a relay AP of Relay2 may be associated with STA4 and STA5. That is, Relay2 may specifically include a relay STA belonging to an upper BSS, a relay AP providing a lower BSS, and a relay function performing functions for a local logical link control (LLC). Detailed configuration of Relay2 may be analogously applied to each of other relays (e.g., Relay1, Relay3).

In an example of FIG. 5, a relay STA of Relay1 may be associated with Root AP, a relay AP of Relay1 may be associated with Relay3 and STA1. A relay STA of Relay3 may be associated with a relay AP of Relay1, a relay AP of Relay3 may be associated with STA2 and STA3. A relay (e.g., Relay3) may not be directly associated with Root AP, rather associated with Root AP via another relay (e.g., Relay1).

As described above, a relay may operate as a relay AP that manages STAs associated to lower side or another relay STAs. Therefore, a relay requires not only a basic STA management, but also management for STAs in Power Save mode.

In addition, considering IoT network characteristics, it is required for a relay to store and maintain STA information for a long time. For example, a Traffic Indication Map (TIM) mode STA in a general WLAN may check whether a data to be transmitted to itself is buffered at an AP based on TIM information included in a beacon frame and the like transmitted by the AP, and may operate accordingly. In an IoT network such as IEEE 802.11ah, considering STA characteristics of transmitting and receiving data at times, STAs may operate as non-TIM mode to reduce power consumption to check TIM information. Such non-TIM mode STA may operate in power save mode for a long time, a relay may be required to manage information of corresponding STAs for a long time.

As described above, as a relay plays a critical role in operations, a functional failure of a relay may seriously impact of overall network performance. That is, a relay may be a Single Point of Failure (SPOF) referred in reliability engineering. Specifically, in case where STAs operating in power save mode for a long time exist in an IoT network, a failure of a relay that is an SPOF may seriously disrupt network operation.

To solve the above problems, the present disclosure describes schemes for a relay to satisfy all requirements of standard and in addition, efficiently duplexing relay functions. More specifically, schemes for supporting relay duplexing by software addition or modification of relay in a WLAN network configured based on IEEE 802.11ah standard.

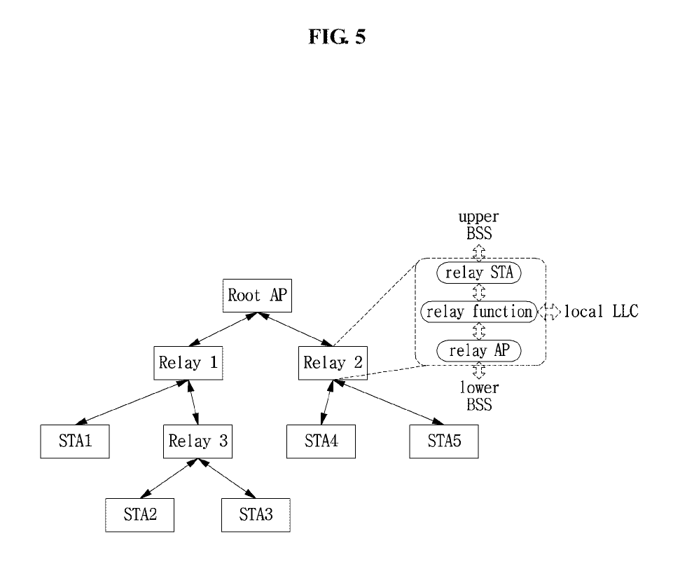

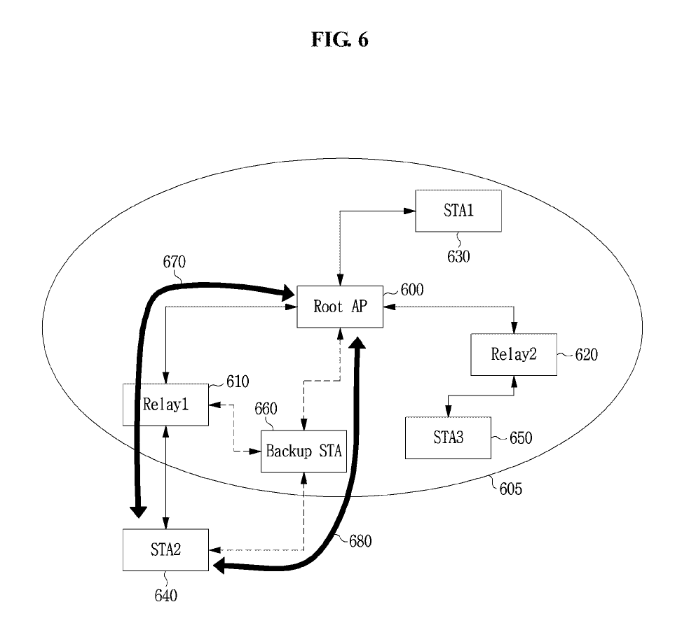

FIG. 6 depicts a network architecture according to the present disclosure.

FIG. 6 exemplifies that nodes such as Relay1 610, Relay2 620, STA1 630 are associated with Root AP 600 in a coverage 605 of Root AP 600. STA1 630 may be directly associated with Root AP 600 without a relay. STA2 640 out of coverage 605 may transmit and receive frames with Root AP 600 via Relay1 610. STA3 650 may be in coverage 605 and transmit and receive frames with Root AP 600 via Relay2 620.

In the present disclosure, Backup STA 660 may correspond to a backup node supporting a relay duplexing of Relay1 610.

An example of FIG. 6 assuming Backup STA 660 supporting a relay duplexing of Relay1 610 is not limited, and analogous description may be applied to a backup node related to other relay (e.g., Relay2 620).

Details of configurations and operations of each entities operating in an example of FIG. 6 will be described.

Root AP 600 may perform functions including forwarding traffics between lower relays (e.g., Relay1 610, Relay2 620) and external networks, and managing lower relays or directly associated STAs (e.g., STA1 630).

Relay1 610 may perform functions including traffic forwarding between lower STAs (e.g., STA2 640) and root AP, and managing lower STAs. When Relay1 610 has lower relays, Relay1 610 may perform functions including traffic forwarding between lower relays and root AP, and managing lower relays.

In addition, Relay1 610 may perform a relay duplexing operation with Backup STA 660. A relay duplexing operation according to the present disclosure may satisfy all requirements of IEEE 802.11ah standard and be configured to define and use information (e.g., vendor-specific information) which is a reserved portion in the standard, and may provide a new function of relay duplexing with maintaining overall standard compatibility. Details of the relay duplexing will be described later.

Backup STA 660 may basically operate as a non-AP STA, and additionally perform functions for relay duplexing with Relay1 610. That is, when Relay1 610 is in normal operation, Backup STA 660 may share information with Relay1 610. When a failure occurs in Relay1 610 which corresponds to a SPOF, Backup STA 660 may detect the failure occurrence and perform functions as a relay AP for STA2 640 covering for Relay1 610. When Relay1 610 is recovered from failure, Backup STA 660 may support the STA2 640 to re-associate with Relay1 610.

STA2 640 may basically operate as a non-AP STA, and additionally perform operations for changing an entity to associate with based on new information defined in relay duplexing as described above. For example, STA2 640 may associate with Backup STA 660 when a failure occurs in Relay1 610, perform operations of re-association with Relay1 610 when Relay1 610 is recovered.

A STA not supporting additional STA operations for relay duplexing defined in the present disclosure, it may detect that an association with a relay or an AP is lost, and perform operations of establish an association with a new relay or an AP. When an association of a STA is lost, information of the STA is not maintained or managed in a network and the STA may need to establish a new association, and overall performance of a network may be decreased. According to relay duplexing operations defined in the present disclosure, information of a STA that has been associated with a relay in which a failure occurs may be consecutively maintained and managed, and overall performance of a network may be increased.

As described above, when Relay1 610 is in normal operation, frame exchange between Root AP 600 and STA2 640 may be performed through Relay1 610 via a first communication path 670. When a failure occurs in Relay1 610, the first communication path 670 is lost, and frame exchange between Root AP 600 and STA2 640 may be performed through Backup STA 660 via a second communication path 680. When Realy1 610 is recovered, frame exchange between Root AP 600 and STA2 640 may be performed through Relay1 610 via the first communication path 670 back again.

Descriptions of Relay1 610 and STA2 640 in the above example may be analogously applied to other relays (e.g., Relay2 620) and other STAs (e.g., STA3 650).

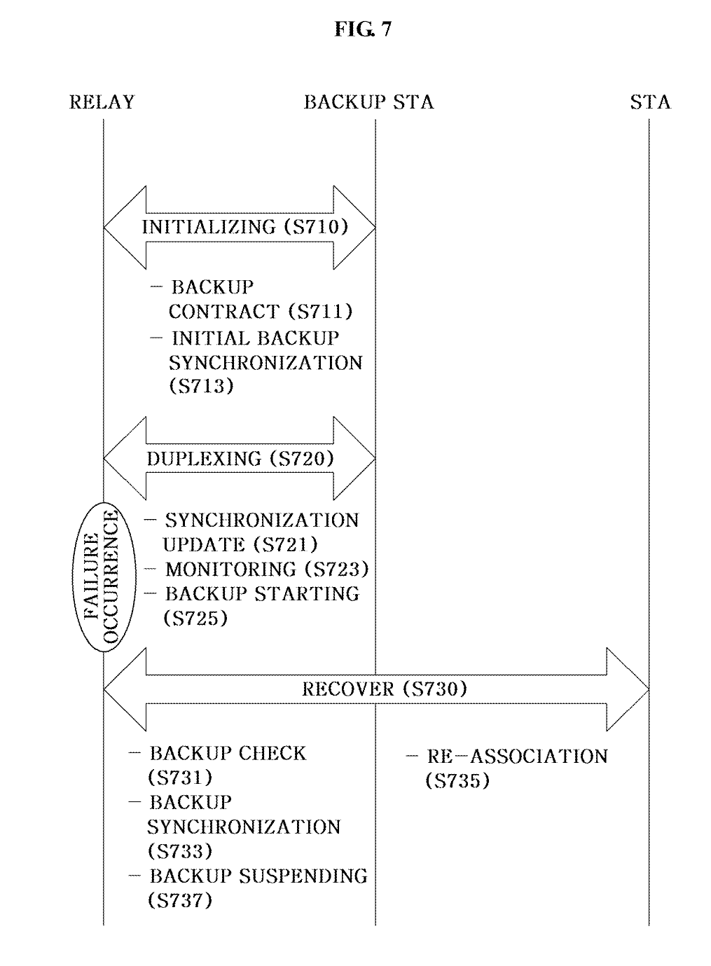

FIG. 7 depicts a relay duplexing operation according to the present disclosure.

In an example of FIG. 7, a relay, a backup STA and a STA may respectively correspond to Relay1 610 Backup STA 660 and STA2 640, which is an example but not limited thereto.

As exemplified in FIG. 7, a relay duplexing operation according to the present disclosure may include an initializing step S710, a duplexing performing step S720 and a recovering step S730.

An initializing step S710 may include a backup contract making step S711, and initial backup synchronization performing step S713 for exchanging required information between a relay and a backup STA.

A duplexing performing step S720 may include a synchronization update performing step S721 between a relay and a backup STA, a monitoring step S723 by a backup STA for monitoring whether a failure occurs in a relay, and a backup starting step S725 which is performed when a backup STA determines or detects that a failure occurs in a relay.

A recovering step S730 may include a backup check step S731 by a relay for checking whether a backup STA is performing backup, a backup synchronization step S733 for synchronizing information when information is updated by a backup STA during when a relay is in failure status, a re-association step S735 for supporting a STA that has been associated with a backup STA to associated back again with a relay, and a backup suspending step S737 for suspending a backup STA functioning as a relay.

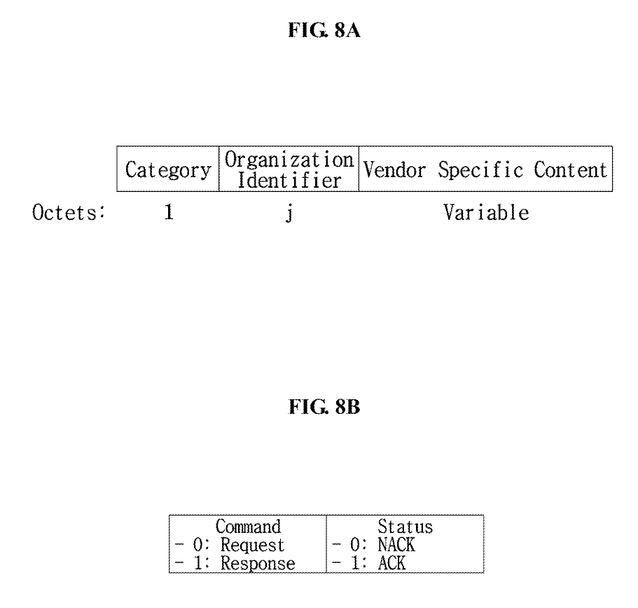

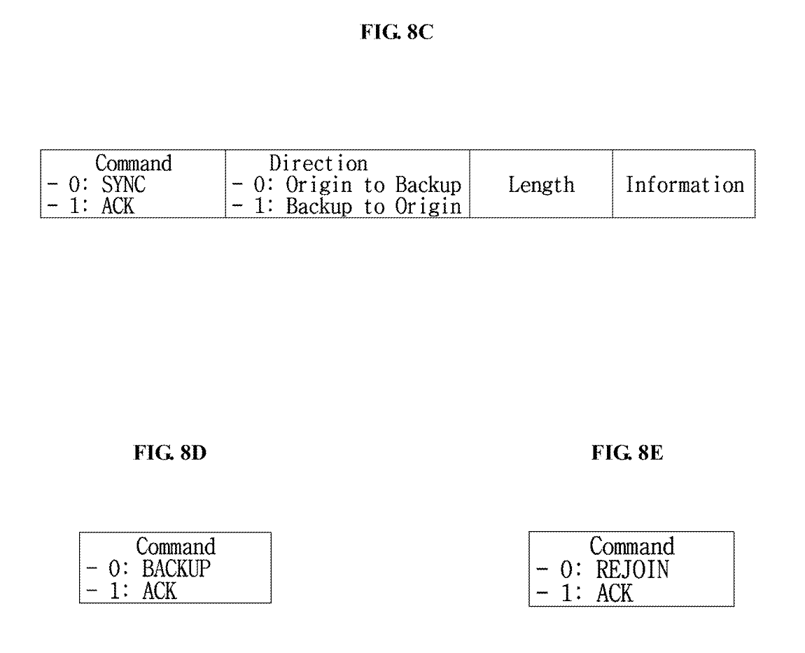

FIGS. 8A to 8E depict frame formats defined for supporting relay duplexing operation according to the present disclosure.

FIG. 8A depicts a vendor-specific action frame format defined for vendor-specific signaling. A vendor-specific action frame is a reserved portion in IEEE 802.11 standard, and may be used for carry information newly defined by a vendor but not defined in the standard.

A category field has 1-octet length, and may have a value (e.g., 127) indicating that a corresponding frame format is a vendor-specific category.

An Organization Identifier (0I) field has j-octet length, and may be set as a value for identifying an entity (i.e., vendor) that defined vendor-specific contents. Here, when an OI field is set as an Organizationally Unique Identifier (OUI) value, then j may have a value of 3. When an OI field is defined as indicating an identifier larger than 3 octet length, the first 3 octets of an OI field may correspond to OUI. Therefore, OI field may include at least an OUI value of 3-octet length.

A vendor-specific content field has a variable length, and may include various information and additional information defined in the present disclosure. Specifically, fields depicted in FIGS. 8B to 8E may be included in a vendor-specific content field of FIG. 8A.

FIG. 8B exemplifies of fields supporting a backup contract operations. For example, a Command field having a value of 0 may indicate a request for a backup contract, and a Command field having a value of 1 may indicate a response of a backup contract. A Status field having a value of 0 may indicate that a backup contract frame transmitted from a counterpart is not received or failed to be decoded (i.e., negative acknowledgment (NACK)), a Status field having a value of 1 may indicate that a backup contract frame is successfully received (i.e., acknowledgment (ACK)).

FIG. 8C exemplifies fields supporting a backup synchronization operations. For example, a Command field having a value of 0 may indicate a backup synchronization, and a Command field having a value of 1 may indicate an ACK. A Direction field having a value of 0 may indicate that a backup synchronization frame is transmitted from an origin of backup (e.g., a relay) to an entity (e.g., a backup STA) functioning as a backup, and a Direction field having a value of 1 may indicate that a backup synchronization frame is transmitted from an entity (e.g., a backup STA) functioning as a backup to an origin of backup (e.g., a relay). A Length field may have a value indicating a length of following field (i.e., Information field). An Information field may include information to backup, and may include various information according to corresponding network characteristics. That is, Information field may include information on a BSS, information on capabilities of a relay, information on STA(s) currently associated with, and so on. The information on STA(s) may include identification information of STA(s) (e.g., MAC address, Association ID (AID) assigned for an association with a relay, a partial AID, and so on), capabilities information of STA(s) and so on which are stored by a relay.

For example, a sequence field, which is not shown in FIG. 8C, may be further defined to reduce overhead of a backup synchronization frame. A value of a sequence field may be incremented by 1 whenever information to backup changes. When a sequence value maintained by a relay is equal to a sequence value maintained by a backup STA, no information is changed and it is not required to perform additional synchronization. When a sequence value maintained by a relay is not equal to a sequence value maintained by a backup STA, it is efficient to deliver information to backup from an entity having a higher sequence value to a counterpart. Therefore, among the fields of a backup synchronization frame of FIG. 8C, a sequence field may be included instead of a Length field and an Information field, thus a sequence value may be delivered first. Accordingly, information to backup may be delivered using a frame format of FIG. 8C when sequence values are different (i.e., when synchronization of backup information is required), additional backup information may not be delivered when sequence values are equal.

FIG. 8D exemplifies examples of fields supporting backup check operations. For example, a Command field having a value of 0 may indicate a request for check whether backup is performing, and a Command field having a value of 1 may indicate an ACK informing that backup is performing.

FIG. 8E exemplifies examples of fields supporting backup rejoin operations. For example, a Command field having a value of 0 may instruct a STA to perform re-association to a relay with which the STA has been associated, and a Command field having a value of 1 may indicate an ACK informing to rejoin.

Vendor-specific frame formats described with reference to FIGS. 8A-8E may be used to form a backup contract frame, a backup synchronization frame, a backup check frame, a backup rejoin frame that will be described hereinafter. However, the scope of the present disclosure is not limited thereto, according to a format of a vendor-specific element included in a frame predefined by a standard document, it may be defined and used as a backup contract element, a backup synchronization element, a backup check element, a backup rejoin element.

Specific embodiments of the present disclosure using various frames defined in FIG. 8A-8E will be described with regard to an initialization step S710 and performing duplexing step S720 and a recovering step S730 of FIG. 7.

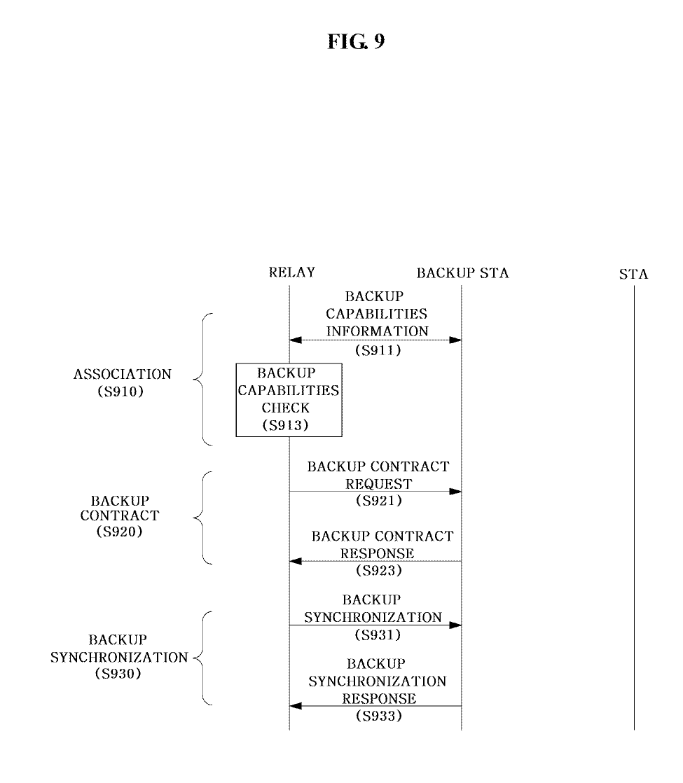

FIG. 9 depicts specified operations of an initializing step according to the present disclosure.

Step S910 shows an association procedure of a relay and a backup STA. For example, a backup STA may transmit an association request frame to a relay (i.e., a relay AP), and in response thereto, a relay may transmit an association response frame to a backup STA to establish an association.

In step S911, a backup STA may deliver its backup capabilities information to a relay.

For example, a backup STA may use reserved bit(s) in a S1G capabilities element included in an association request frame to deliver its backup capabilities information to a relay. For example, S1G capabilities element may have a length of 10 octets (i.e., 80 bits), Bit 0 (BO) to Bit 72 (B72) may be configured as fields defined in a standard document, Bit 73 (B73) to Bit 79 (B79) may be defined as reserved bits. One bit of reserved bits (e.g., B73) may be defined as a bit indicating whether a backup STA support or not, additional one bit (e.g., B74) may be defined as a bit indicating Root AP accessibility.

An association request frame transmitted by a backup STA may further include information on a type (e.g., it may be included in S1G capabilities element included in an association request frame), a listen interval, and so on.

A relay may identify strength of signal received from a backup STA in a form of Received Signal Strength Indicator (RSSI).

A relay may identify, based on information on a backup STA, whether a backup STA supports power save modes (PS modes) including a sleep mode, an awake mode and so on, timing information for operating in power save mode, and so on.

In step S913, a relay may determine whether to make a backup contract with a backup STA based on information on the backup STA.

A relay may basically determine at least one backup STA candidate based on whether a backup STA supports functions for operating as a relay.

In addition, a relay may determine whether to make a contract with a backup STA, based at least one of, for example, root AP accessibility, type of STA, listen interval, RSSI, or PS mode.

For example, a STA having the following characteristics may be preferred as a backup STA.
STA capable of accessing a root AP
non-sensor type STA
STA having short listen interval
STA having high RSSI
STA not in PS mode (i.e., in active or awake state)

Above preferences are examples but not limited thereto. Further, a part of the above preferences may be considered, or a backup STA may be selected among backup STA candidates in consideration of additional preferences. For example, a sensor type STA may be selected as a backup STA when only sensor type STAs exists in overall network. STA having shorter listen interval may be preferred, but a STA having longer listen interval may be selected as a backup STA in consideration of a network characteristics.

Step S920 shows a procedure for making backup contract of a relay and a backup STA (corresponding to S711 of FIG. 7).

In step S921, a relay may transmit a backup contract request frame to a backup STA. For example, a relay may transmit, to a selected backup STA, a vendor-specific action frame including a vendor-specific content with Command field having a value of 0 in an example of FIG. 8B.

In step S923, a backup STA may transmit a backup contract response frame to a relay. For example, a backup STA receiving a backup contract request frame may transmit, to a relay, a vendor-specific action frame including a vendor-specific content with Command field having a value of 1 and Status field having a value of 1.

Step S930 shows a procedure for performing backup synchronization of a relay and a backup STA (corresponding to S713 of FIG. 7).

In step S931, a relay may transmit a backup synchronization frame to a backup STA. For example, a relay may transmit, to a backup STA, a vendor-specific action frame including a vendor-specific content with Command field having a value of 0, Direction field having a value of 0 and Length field and Information field configured according to size and content of information to be delivered.

In step S933, a backup STA may transmit a backup synchronization response frame to a relay. For example, a backup STA may transmit, to a relay, a vendor-specific action frame including a vendor-specific content with Direction field having value of 1.

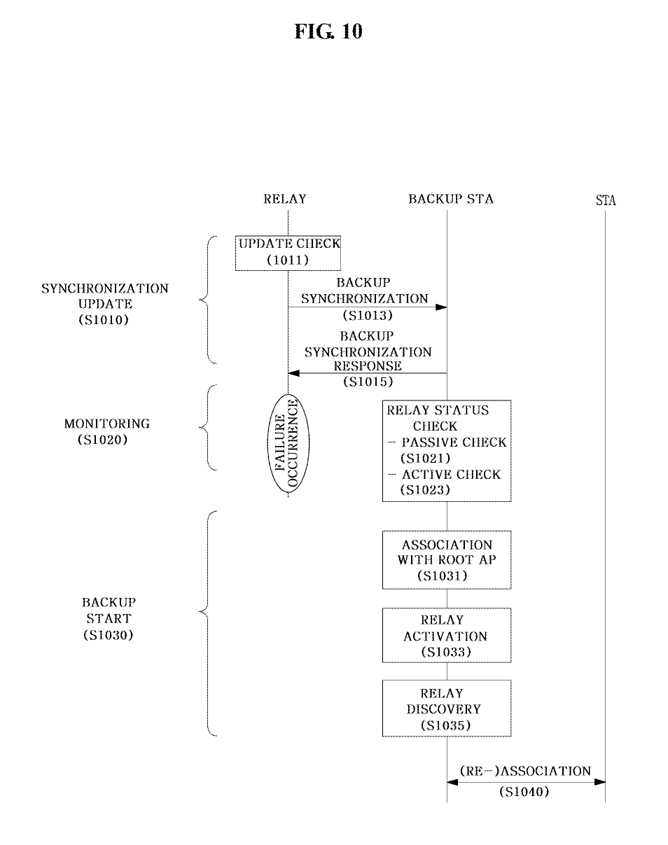

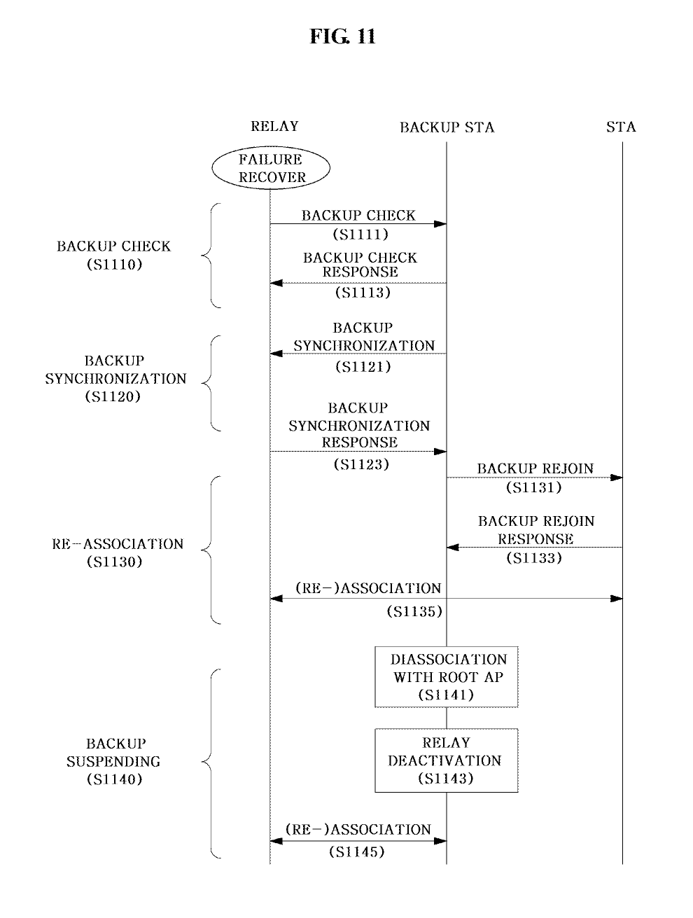

FIG. 10 depicts specified operations of a synchronization performing step according to the present disclosure.

Step S1010 shows a procedure for performing backup synchronization update of a relay and a backup STA (corresponding to S721 of FIG. 7).

In step S1011, a relay may determine whether information delivered from a relay to a backup STA in step S931 of FIG. 9 have been changed or not. When it is determined that any of the information has been changed, a relay may determine that an update is required, and may use a backup synchronization frame (e.g., FIG. 8C) to deliver changed information to a backup STA (S1013). In response thereto, a backup STA may transmit a backup synchronization response frame (e.g., FIG. 8C) to a relay (S1015). When no information has been changed, steps S1013 to S1015 may not be performed.

Step S1020 shows a procedure for monitoring relay status by a backup STA (corresponding to S723 of FIG. 7).

Step S1020 may not be limited to be performed sequentially after step S1010, but a backup STA that has made a backup contract may monitor a status of a relay persistently or periodically.

For example, a backup STA may check whether a beacon frame which is periodically broadcast by a relay (i.e., a relay AP) is received or not. It may be referred to as a passive relay status check (or passive scanning). When a beacon frame is not received, it may be determined that a failure has occurred in relay.

A backup STA may perform an active relay status check (or active scanning) using a probe request and a probe response. For example, when a backup STA has transmitted a probe request frame to a relay and fails to receive a probe response frame within a predetermined probe response waiting time, it may be determined that a failure has occurred in relay.

When performing a relay status check in passive check scheme or in active check scheme, a passive check scheme may be performed basically, but an active check scheme may be performed when a listen interval of a backup STA is longer than a predetermined criteria value. For example, an active check scheme may be applied when a listen interval of a backup STA is longer than a criteria for Beacon Interval.

Step S1030 shows a procedure for initiating a backup by a backup STA (corresponding to S725 of FIG. 7).

In step S1031, a backup STA may establish an association with a root AP directly, a root AT via a relay, or another relay.

In step S1033, a backup STA may perform a procedure for relay activation. For example, a backup STA may be activated as a relay by exchanging a relay activation request frame and a relay activation response frame with a root AP.

In step S1035, a backup STA may perform a relay discovery procedure. For example, when receiving a frame including a relay discovery element from another STA, a backup STA may determine whether a relay function can be provided for the corresponding STA, and may response accordingly.

In step S1040, a backup STA being ready for operate as a relay may establish an (re-)association with a STA. For example, a backup STA may establish an association with a STA by exchanging (re-)association request frame and (re-)association response frame. Then, the STA may exchange frame with a root AP through the backup STA.

While performing the above procedures, a backup STA may persistently or periodically monitor whether a relay is recovered to normal operations. For example, a backup STA may perform monitoring in a passive check scheme using a beacon frame or in an active check scheme using a probe request and a probe response.

FIG. 11 depicts specified operations of a recovering step according to the present disclosure.

Step S1110 shows a procedure for backup check by a relay with respect to a backup STA (corresponding to S731 of FIG. 7).

In step S1111, a relay may check whether a backup STA is performing backup by transmitting a backup check frame to the backup STA. For example, a relay may transmit, to a backup STA, a vendor-specific action frame including a vendor-specific content with Commanding field having a value of 0 in an example if FIG. 8D.

In step S1113, a backup STA may transmit a backup check response frame to a relay. For example, a backup STA may transmit to a relay, a vendor-specific action frame including a vendor-specific content with Commanding field having a value of 1 in an example if FIG. 8D.

Step S1120 shows a procedure for performing backup synchronization of a relay and a backup STA (corresponding to S733 of FIG. 7).

A backup STA may operate as a relay during a failure has occurred in a relay, and in the meantime, information on STA(s) may be changed. Therefore, a relay recovered from a failure may perform a synchronization through a backup STA to obtain information that have been changed in the meantime

In step S1121, a backup STA may transmit a backup synchronization frame to a relay. For example, a backup STA may transmit, to a relay, a vendor-specific action frame including a vendor-specific content with Command field having a value of 0, Direction field having a value of 1 and Length field and Information field configured according to size and content of information to be delivered.

In step S1123, a relay may transmit a backup synchronization response frame to a backup STA. For example, a relay may transmit, to a backup STA, a vendor-specific action frame including a vendor-specific content with Command field having a value of 1 and Direction field having value of 0 in an example of FIG. 8C.

In addition, a relay may transmit, to a backup STA, using a backup synchronization frame, a sequence value for information stored in the relay. A backup STA may compare a sequence value stored in the backup STA with a sequence value received from a relay, and may determine whether an update of information stored in relay is required or not. When it is determined that an updated is required, backup information may be synchronized by performing steps S1121 and S1123. When it is determined that an updated is not required, steps S1121 and S1123 may be omitted.

Step S1130 shows a procedure for a STA to perform re-association with a relay (corresponding to S735 of FIG. 7).

In step S1131, a backup STA may inform a STA that re-association with a relay with which the STA has been associated is allowed, or instruct a STA to perform re-association. For example, a backup STA may transmit, to a STA, a vendor-specific action frame including a vendor-specific content with Command field having a value of 0 in an example of FIG. 8E.

In step S1133, a STA may transmit a backup rejoin response frame to a backup STA. For example, a STA may transmit, to a backup STA, a vendor-specific action frame including a vendor-specific content with Command field having a value of 1 in an example of FIG. 8E.

In step S1135, a STA may establish an (re-)association with a relay. For example, a STA may establish an (re-)association by performing a procedure including transmitting an (re-)association request frame to a relay and receiving an (re-)association response frame from the relay.

Procedures for backup rejoin and response of steps S1131 and S1133 may be omitted. That is, a STA may autonomously detect that a relay is recovered from a failure, and establish (re-)association with the relay.

Step S1140 shows a procedure for suspending a backup by a backup STA (corresponding to S727 of FIG. 7).

In step S1141, a backup STA may perform diassociation with a root AP.

In step S1143, a backup STA may perform a relay deactivation procedure. For example, a backup STA may deactivate of functions as a relay by exchanging a relay deactivation request frame and a relay deactivation response frame.

In step S1145, a backup STA may establish an (re-)association with a relay. For example, a backup STA may establish an (re-)association with a relay by transmitting an (re-)association request frame to the relay and receiving an (re-)association response frame from the relay. Accordingly, a backup STA may prepare for performing a backup by persistently performing operations of monitoring (e.g., S1020) for a failure of a relay.

As described with reference to the above embodiments, when a traffic path (e.g., 670 of FIG. 6) is lost due to a failure occurred in a relay that has been in normal operations, a new traffic path (e.g., 680 of FIG. 6) through a backup STA may be supported by relay duplexing operations. Accordingly, even when a failure occurs in a relay, STA managements and traffic transmission and reception may be supported persistently and stably.

While the afore-described exemplary methods of the present disclosure have been described as a series of operations for simplicity of description, this does not limit the sequence of steps. In some embodiments, steps may be performed at the same time or in a different sequence. All of the exemplary steps are not always necessary to implement the method proposed by the present disclosure.

The foregoing embodiments of the present disclosure may be implemented separately or combinations of two or more of the embodiments may be implemented simultaneously, for the afore-described exemplary methods of the present disclosure.

The present disclosure includes an apparatus for processing or performing the method of the present disclosure (e.g., the wireless device and its components described with reference to FIGS. 1, 2, and 3).

The present disclosure includes software or machine-executable instructions (e.g., an operating system (OS), an application, firmware, a program, etc.) for executing the method of the present disclosure in a device or a computer, and a non-transitory computer-readable medium storing the software or instructions that can be executed in a device or a computer.

While various embodiments of the present disclosure have been described in the context of an IEEE 802.11 system, they are applicable to various mobile communication systems.

What is claimed:

1. A method for relay duplexing in a wireless local area network, the method comprising:
monitoring, by a backup station (STA), a status of a relay;
when determining that a failure occurred at the relay, activating the backup STA as a relay; and
establishing, by the backup STA, an association with a STA that has been associated with the relay.

2. The method of claim 1, further comprising:
performing, by the backup STA, a backup synchronization with the relay,
wherein the backup synchronization includes delivering, from the relay to the backup STA, information to backup.

3. The method of claim 2, wherein the backup synchronization includes:
an initial backup synchronization performed firstly after the backup STA makes a backup contract with the relay; and
a backup synchronization update performed when the information to backup is changed at the relay.

4. The method of claim 2,
wherein the backup synchronization includes:
receiving, by the backup STA from the relay, a backup synchronization frame; and
transmitting, by the backup STA to the relay, a backup synchronization response frame.

5. The method of claim 4,
wherein the backup synchronization frame and the backup synchronization response frame correspond to a vendor-specific action frame or a frame including a vendor-specific element.

6. The method of claim 3, wherein the backup contract includes:
selecting the backup STA among at least one backup STA candidate, based on information on backup capabilities of the backup STA provided by an association of the relay and the backup STA; and
exchanging a backup contract request frame and a backup contract response frame between the selected backup STA and the relay.

7. The method of claim 6, wherein the backup STA is selected based on at least one of whether supporting relay functions, whether being accessible to a root access point (AP), whether being a sensor type, a listen interval, a received signal strength, or a power save mode.

8. The method of claim 6,
wherein the backup contract request frame and the backup contract response frame correspond to a vendor-specific action frame or a frame including a vendor-specific element.

9. The method of claim 1, wherein the activating the backup STA as a relay includes:
establishing, by the backup STA, an association with a root AP; and
exchanging a relay activation request frame and a relay activation response frame between the backup STA and the root AP.

10. The method of claim 1, the method further comprising:
when the relay is recovered, receiving, from the relay, a backup check frame to check whether the backup STA is performing backup; and
transmitting, by the backup STA to the relay, a backup check response frame.

11. The method of claim 10,
wherein the backup check frame and the backup check response frame correspond to a vendor-specific action frame or a frame including a vendor-specific element.

12. The method of claim 1,
after the relay is recovered, a backup synchronization is performed with the relay for information updated at the backup STA during when the relay is in failure status.

13. The method of claim 12, wherein the backup synchronization performed after the relay is recovered includes:
transmitting, by the backup STA to the relay, a backup synchronization frame; and
receiving, by the backup STA from the relay, a backup synchronization response frame.

14. The method of claim 1, further comprising:
when the relay is recovered, instructing, by the backup STA, the STA that has been associated with the relay, to perform re-association with the relay.

15. The method of claim 14, wherein the instructing further includes:
transmitting, by the backup STA to the STA, a backup rejoin frame; and
receiving, by the backup STA from the STA, a backup rejoin response frame.

16. The method of claim 15,
wherein the backup rejoin frame and the backup rejoin response frame correspond to a vendor-specific action frame or a frame including a vendor-specific element.

17. The method of claim 1,
wherein the backup STA performs a relay deactivation when the relay is recovered and the STA that has been associated with the relay is re-associated with the relay.

18. The method of claim 17, further comprising:
performing, by the backup STA, a diassociation with a root AP; and
establishing, by the backup STA, an association with the relay.

19. The method of claim 1,
wherein the monitoring is performed persistently or periodically.

20. An apparatus for a backup station (STA) performing relay duplexing in a wireless local area network, the apparatus comprising:
a transceiver;
a memory; and
a processor,
wherein the processor is configured to:
monitor a status of a relay;
when determining that a failure occurred at the relay, activate the backup STA as a relay; and
establish an association with a STA that has been associated with the relay.
